(19) United States
(12) Patent Application Publication
(10) Pub. No.: US 2006/0246282 A1
(43) Pub. Date: Nov. 2, 2006

(54) Two-side self-adhesive tape whose sides have different adhesive force in particular for removably sticking flexible compact discs to curved surfaces

(76) Inventors: Nicolai Bohm, Hamburg (DE); Carsten Bohmer, Pinneberg (DE); Philippe Hesse, Buchholz (DE); Nataly Hoppe, Hamburg (DE); Uwe Schumann, Pinneberg (DE); Sianty Sunarto, Singapore (SG)

Correspondence Address: NORRIS, MCLAUGHLIN & MARCUS, P.A., 875 THIRD AVE, 18TH FLOOR, NEW YORK, NY, 10022, US

(21) Appl. No.: 10/568,603

(22) PCT Filed: Aug. 12, 2004
(86) PCT No.: PCT/EP04/09032

§ 371 Date: Jun. 19, 2006

(30) Foreign Application Priority Data
Aug. 15, 2003 (DE) 103 38 133.3

(51) Int. Cl. B32B 7/12

(52) U.S. Cl. 428/355 EN; 428/354

(57) ABSTRACT

The invention relates to a two-side self-adhesive tape whose sides have different adhesive forces and are provided with at least one adhesive layer. Said invention is characterised in that the glue of the less adhesive layer is based on ethylene vinyl acetate copolymer whose vinyl acetate part in the copolymer ranges from 25 to 92 mass %. in a preferred embodiment from 40 to 70 mass %, the adhesive substance can be possibly mixed to additives such as adhesive resins, softeners, antioxidants and fillers.

The invention relates to a double-sidedly pressure-sensitively adhesive tape having sides which differ in adhesive strength, optionally in the form of punched or cut shapes, for the adhesive bonding and also residue-free and damage-free redetachment of flexible storage media of the CD, CD-ROM or DVD type, for example, on planar and in particular also on curved, bent or creased surfaces, substantially without detachment of the flexible storage media particularly in the edge region or marginal region during the period of bonding, where the side to which the flexible storage media are stuck essentially does not feel tacky and/or does not adhere to human skin.

Flexible optical storage media such as those of the CD or CD-ROM type are known, for example, from WO 01/52252 A1. Storage media of this kind consist in their product structure of a polymeric sheet, typically from the group of the polyesters or polycarbonates, a sol-gel layer applied thereon or alternatively a layer of a photopolymer, optionally a further, metallization layer, and an optional, additional protective varnish layer. In contrast to a conventional CD, the information is read out not through the polymeric sheet but from the opposite side: the either open or, where appropriate, metallized sol-gel layer, alternatively the photopolymer or, if desired, through the protective varnish layer. Consequently this side, referred to below for short as readout side, requires particular protection against mechanical or other damage.

By virtue of their flexibility such storage media are able to conform to the surfaces of many articles of everyday use and/or to their packaging, for example cans, including beverage cans, bottles, pouches, bags, boxes, cartons or crates, and so on, thereby opening up the possibility in principle of transporting them, as information carriers and advertising media, to the target individuals in space-saving fashion and without great effort.

Suitable means of affixing these storage media to the utility articles and/or their packaging include in principle double-sided adhesive tapes or adhesive sheets and also pressure-sensitive adhesives (PSAs) applied without backings as a film to antiadhesive materials (such systems being known as transfer fixatives). The known adhesive articles of the said kind, however, have drawbacks.

The majority of customary double-sided adhesive articles have identical adhesive strength on both sides. The known adhesive articles of this type have the disadvantage either of adhering so strongly to the readout side of the flexible storage medium that the said storage medium cannot be detached from the adhesive article without damaging the readout side or of adhering so weakly to the utility articles or their packaging that secure fixing is not ensured.

Double-sided adhesive articles whose sides have different adhesive strengths are likewise known, for example from DE 43 16 317 A1. As the PSA for the side of the adhesive article to which the readout side of the flexible storage medium is to be stuck it is possible for diverse known systems to be used, all of which, however, are hampered by weaknesses.

PSAs based on natural rubber can be formulated in such a way that they initially have a suitable bond strength and to begin with are also readily redetachable. These PSAs, however, are not stable to ageing. A possible consequence of this after just a short time is the development of highly greasy residues on the storage media or residues which have hardened to a paintlike state.

Polyacrylate-based PSAs, although substantially more stable to ageing, are generally subject to a sharp increase in peel force on the surfaces of the storage media. The term “peel increase” is used by the person skilled in the art to describe the increase in bond strength during storage of the adhesive bond. These PSAs are therefore difficult to redetach and, moreover, generally leave residues on the surfaces. If these PSAs are crosslinked chemically or by radiation it is, admittedly, easier to detach the bonded storage media from them; however, in the case of bonds on curved surfaces there are often instances of unintended detachment of the storage media from the PSA, especially in the edge region or marginal region. Furthermore, both crosslinked and non-crosslinked polyacrylate PSAs lead frequently to irreversible, visually perceptible changes on the surface of the readout side of the storage medium, referred to as deformations. Observations made include the impressions of the adhesive tape in the region of the edges and a gumming of the surface of the readout side of the storage medium, probably caused by the rough PSA surface.

It is an object of the present invention, therefore, to provide a double-sidedly pressure-sensitively adhesive tape with which flexible storage media of the CD, CD-ROM or DVD type, for example, can be adhesively bonded from their readout side to surfaces, including in particular curved, bent or creased surfaces, of articles of everyday use or their packaging, and detached from them again, without the storage media being damaged or having residues left on them, and which no longer exhibits the depicted drawbacks of the prior art, or at least not to the same extent. In particular, there should be no instances of unintended detachment in the edge region or marginal region of the adhesive bonds during the period of bonding, since in that case the readout side of the storage medium would no longer be sufficiently protected against damage by external influences at the points in question. Moreover, following the detachment of storage medium, the adhesive tape should not feel tacky, since that would detract from the quality of the product to which the adhesive tape was bonded.

This object is achieved by means of a double-sidedly pressure-sensitively adhesive tape, optionally in the form of punched or cut shapes, as specified in the main claim. The dependent claims provide advantageous developments of the adhesive tape and possibilities for its use.

The invention accordingly provides a double-sidedly pressure-sensitively adhesive tape having sides which differ in adhesive strength, comprising at least one adhesive layer, where
the pressure-sensitive adhesive of the more weakly adhering adhesive layer is based on an ethylene-vinyl acetate copolymer with a vinyl acetate content in the copolymer of from 25 to 92% by weight, preferably 40 to 70% by weight;
the adhesive mass is optionally mixed with additives such as tackifying resins, plasticizers, ageing inhibitors or fillers.
   The more weakly adhering side of the adhesive tape, in accordance with the invention, essentially does not adhere to human skin or does not feel tacky.

The adhesive layer may thus be produced from the solution or solvent-free using the extrusion or coextrusion process and in fact, depending on the embodiment, may be applied to an antiadhesive material in web form or to the backing material of a multilayer adhesive band.

Double-sided adhesive tapes of the invention are composed in one optional embodiment of three or more layers, namely a backing layer which may in turn be a laminate of two or more individual layers, a known PSA layer, which is not restricted in terms of its polymer basis, and, applied to the other side of the backing, an inventive PSA layer, based on ethylene vinyl acetate copolymer, the last-mentioned layer always having a lower bond strength than the first-mentioned.

In further optional embodiments, adhesive tapes of the invention are composed of the two different PSA layers, the two layers being applied directly to each other. An unbacked two-layer laminate of this kind comes under the heading of the so-called transfer fixatives, and is produced by applying the PSA layers to an antiadhesive material in web form, and is also dispensed in this form or, optionally, processed further in cutting or punching operations. At least the more weakly adhering side is formed from the EVA-based PSA.

In order to improve the anchorage between the individual layers it is possible to employ all known methods of surface pretreatment, such as, for example, corona pretreatment, flaming or gas-phase treatment (fluorination, for example). It is also possible to use all known methods of priming, in which case the primer layer may be applied either from solution or from dispersion or else in an extrusion or coextrusion process.

Typical overall product thicknesses are from 20 μm to 300 μm, preferably from 30 μm to 200 μm, more preferably from 40 μm to 100 μm, without wishing to restrict the invention with these figures.

As backing layers it is possible to use all known sheets in web form or multi-layer sheet laminates. These sheets or laminates may be either thermoplastic or thermosetting in nature. Examples of preferred backing sheets are those based on PETP, polyamide, PVC or polyolefin, in the latter case especially PE or PP. It is also possible to use elastomer sheets, including thermoplastic elastomer sheets. Examples are sheets based on styrene block copolymers, natural rubber, polyisoprene, polybutadiene, polychloroprene rubber, butyl rubber, silicone rubber, EPDM rubber or ethylene-propylene copolymers, polyurethanes (such as A-3600 (Wolff Walsrode), Platilon UO 1 (Atochem), Desmopan (Bayer) or Elastollan (Elastogran), for example), vinyl copolymers and ethylene-vinyl acetate copolymers.

The sheets may include further formulating constituents, such as ageing inhibitors (antioxidants), light stabilizers, UV absorbers, colour pigments, dyes, fillers and other auxiliaries and additives, for example.

The backing sheets or individual layers of the backing sheets may further have been foamed with a gas or may have undergone a change in volume resulting from the addition of expandable or ready-expanded microballoons or hollow or solid glass microbeads.

As backing layers it is likewise possible to employ metal foils, wovens, non-wovens, crêped or non-crêped papers and also laminates of the individual layers and sheets.

The overall thickness of the backing layers employed is typically between 10 and 100 μm, without wishing to restrict the invention with these figures.

The known PSA layer for the more strongly adhering side of the adhesive tape has the function of adhering to surfaces of customary articles of everyday use or to their packaging, such as cans, including beverage cans, bottles, pouches, bags, boxes, cartons or crates, and so on, so effectively that there is no unwanted detachment, or at least no premature unwanted detachment, of the adhesive tape from the utility articles or their packaging. Such a function is fulfilled by a large number of known PSAs or PSA types which differ in their polymer basis. Suitable examples include PSAs based on polyacrylate, natural rubber, styrene block copolymers, styrene-butadiene rubber or polyurethane, to name but a few. The PSAs in question can be crosslinked or non-crosslinked. The PSAs can be applied to the preferably present backing layer by all known methods, including for example from solution or dispersion, in an extrusion or coextrusion process, by roller application or spray application or in a reactive coating process.

In selecting the PSAs care should be taken to ensure that the adhesive strengths which are attained on the utility articles or their packaging ensure secure fixation. Suitable PSAs include essentially all those whose bond strength, measured indicatively on steel (see Test Methods), is greater than about 1.0 N/cm, preferably greater than 2.0 N/cm, more preferably greater than 3.0 N/cm. In any case, the bond strength of the known PSA which is intended to adhere to the surfaces of customary utility articles and/or their packaging is higher than that of the ethylene-vinyl acetate copolymer-based PSA to which the readout side of the storage medium is to adhere.

The ethylene-vinyl acetate copolymer-based self-adhesive mass envisioned for the more weakly adhering side of the adhesive tape is to ensure the flexible data medium's easy, destruction and residue-free redetachability.

The present invention's copolymers of ethylene and of vinyl acetate are industrially produced by free-radical polymerization to form random copolymers. Various processes are employed depending on the comonomer ratio. The high pressure process is employed for low vinyl acetate contents below about 45 percent by weight, the medium pressure process for medium vinyl acetate contents of about 40 to 90 percent by weight and the low pressure process for contents above about 80 percent by weight.

Of the entire commercially available range of ethylene-vinyl acetate copolymers, types between 25% and 92% and particularly between 40 and 70% by weight will prove to be suitable, depending on the material embodiment of the readout side of the flexible data medium.

The ethylene-vinyl acetate copolymers of the present invention are readily processable from solution, for example from toluene, above a vinyl acetate content of 40 percent by weight, and also as a thermoplastic melt, by extrusion or coextrusion processes, without restriction of the vinyl acetate content.

Bond strength modifier additives, i.e. adhesive resins, including resins based on rosin and all its derivatives, aliphatic or aromatic hydrocarbyl resins, terpene resins or phenolic resins can be added not only in solution but also in the melt.

Plasticizers such as the polyethers polypropylene glycol or polytetrahydrofuran or mineral oils and also low molecular weight liquid or semi-liquid polymers are further suitable for fine-tuning the adhesive properties.

Light stabilizers, such as UV absorbers, can also optionally be used. Light stabilizers used are those disclosed in Gaechter and Müller, Taschenbuch der Kunststoff-Additive, Munich 1979, in Kirk-Othmer (3rd) 23, 615-627, in Encycl. Polym. Sci. Technol. 14, 125-148 and in Ullmann (4th) 8, 21; 15, 529, 676.

Useful fillers include all finely ground solid addition materials such as for example chalk, magnesium carbonate, zinc carbonate, kaolin, barium sulfate, titanium dioxide or calcium oxide. Further examples are talc, mica, silica, silicates or zinc oxide. Mixtures thereof can also be used.

The bond strength of the ethylene-vinyl acetate copolymer-based PSA for the more weakly adhering side of the adhesive tape is typically between about 0.01 and 0.4 N/cm, measured on steel (see Test Methods), or between about 0.1 and 0.8 N/cm, preferably between 0.2 and 0.6 N/cm, measured on the readout side of the storage medium (see Test Methods).

With their more strongly adhering side, adhesive tapes of the invention have bond strengths on steel (see Test Methods), determined at a peel angle of 180°, of more than about 1.0 N/cm, preferably more than 2.0 N/cm, more preferably more than 3.0 N/cm. The more strongly adhering side adheres to the surfaces of customary articles of everyday use and/or to their packaging, such as cans, including beverage cans, bottles, pouches, bags, boxes, cartons or crates, and so on, so well that in normal use there is no unwanted detachment, or at least no premature unwanted detachment, of the adhesive tape from the utility articles or their packaging.

With adhesive tapes of the invention it is possible to bond flexible CDs, CD-ROMs or other storage media of the type described to cylindrical bodies having typical diameters of at least greater than or equal to about 5 cm for periods of at least 3 months without any instances of spontaneous detachment, particularly not in the marginal region or edge region of the bent (and therefore under stress) CDs or CD-ROMs.

Storage media can be detached by hand from the adhesive tapes of the invention in each case without damage. Surprisingly it has been found that the pressure-sensitive adhesive exposed after the storage media have been detached, despite the very good adhesion properties to storage media, sticks neither to the skin nor to paper and/or does not feel sticky. The storage media, following their detachment from the adhesive tape of the invention, have no deformations, spots or residues detrimental to the quality of the storage media, or at least none which are visible.

As well as for the adhesive bonding and also residue-free and damage-free redetachment of flexible storage media, such as those of the CD, CD-ROM or DVD type on curved, bent or creased surfaces, for example, double-sidedly pressure-sensitively adhesive tapes of the invention having sides which differ in adhesive strength are also suitable for diverse other utilities. For example, they can be used to bond both flexible and non-flexible storage media to planar or substantially planar surfaces, such as in books, magazines, brochures and the like, for example. Furthermore, adhesive tapes of the invention are suitable for the adhesive bonding (redetachably without residue or damage) of customer cards, credit cards or the like to personal letters for sending out the cards. Adhesive tapes of the invention are generally suitable for fixing lightweight articles, particularly those with surfaces of plastic, metal or glass, in such a way that they can be redetached without residue or damage.

The following test methods were used briefly to characterize the specimens produced in accordance with the processes described.
Bond strength (1800 peel angle)
The bond strength was tested in accordance with PSTC-101. According to this method the adhesive tapes of the invention with a width of 10 mm are applied to different substrates (steel, the readout side of a flexible CD (in this case a modified epoxy protective varnish), the backing side of a flexible CD (in this case PETP), paper (in this case commercially customary paper for copiers)) and then peeled off under defined conditions by means of a tensile testing machine.
The peel angle is in each case 180° and the separation speed 300 mm/min. The figure reported is the average value for the peel force in the region in which the adhesive tape has detached from the substrate by between 10 mm and 40 mm. The force required for peeling is the bond strength, which is reported with the units “N/cm”.
The more weakly adhering side of the adhesive tape was tested in each case on the substrates indicated. The more strongly adhering side, whose PSA is known, was tested only on steel.
The steel substrate is specified as follows:
stainless steel, V2A (16/6), material No. 1.4301 according to DIN 17440, polished, arithmetic mean roughness 0.05 to 0.2 μm.
Long-term bond strength on cylindrical bodies
To determine the long-term bond strength and detachment characteristics on curved surfaces, adhesive tapes of the invention are bonded with their more strongly adhering side to a steel cylinder (radius: 2.5 cm). Then flexible CDs (thickness: approximately 125 μm, diameter: approximately 9.0 cm; surface 1 (backing layer of the CD): polyester; surface 2 (readout side of the CD): modified epoxy varnish) are bonded both with the readout side and, in a second test, with the backing side to the more weakly adhering side of the adhesive tape.
The adhesive bonds are assessed for detachment of the CDs from the adhesive tape, especially in the edge region, after 3 months of storage at room temperature (23° C.), at +50° C. and after storage with temperature cycling (4 cycles each of 1 week at −10° C., 1 week at room temperature, and 1 week at +50° C.). The result is reported as the radial detachment distance in “mm” units.
The CDs are then deliberately detached by hand at room temperature and examined and evaluated for residues originating from the PSA (for example shadows, coverings, spots) and for deformation or other damage. The readability of the data is tested subsequently.
The adhesion of the PSA layer exposed following the detachment of the CDs to the skin is determined in sensory testing.

The intention of the text below is to illustrate the invention with reference to examples, though without wishing thereby to restrict it.

### EXAMPLES

The following backing sheets and backing materials are used in the examples:
commercial polyester film (PETP)
thickness: 12 μm, width: 50 cm, manufacturer: Mitsubishi
commercial BOPP film
thickness: 28 μm, width: 50 cm, manufacturer: Radici
film of Elvax 750® (EVA-based elastomer, VA content 9% (w/w), manufacturer: Du Pont)
thickness of extrudate: 50 μm, width: 50 cm.

The following known adhesives are used for the more strongly adhering side of the adhesive tape of the invention in the examples:

Known PSA 1:

(Acrylate Copolymer-Based Type)

A 2 l reactor conventional for free-radical polymerizations is charged with
20 g hydroxypropyl acrylate
60 g methyl acrylate
210 g ethylhexyl acrylate
210 g butyl acrylate
300 g acetone/special boiling point spirit 60/95 (1:1).

After nitrogen gas has been passed through the reactor with stirring for 45 minutes the reactor is heated to 58° C. and 0.2 g azo-bis-isobutyronitrile (AIBN) is added. Subsequently the external heating bath is heated to 75° C. and the reaction is conducted constantly at this temperature.

After a reaction time of 1 h a further 0.2 g AIBN is added.

After 2.5 h and 5 h dilution is carried out in each case with 150 g of acetone/special boiling point spirit 60/95 (1:1).

The reaction is terminated after a reaction time of 48 h and the reaction mixture is cooled to room temperature.

Finally, based on the quantitative ratios above, 2.5 g Desmodur Z® are added. The PSA is hence ready for coating.

Known PSA 2:

(Natural Rubber-Based Type)

A PSA of the following composition which is prepared by conventional methods in a compounder is used:

| Weight | | | |
|---|---|---|---|
| fraction (% | | | |
| by wt.) | Trade name | Chemical basis | Manufacturer/supplier |
| 46.0 | Natural rubber SMR CV50 ® | Natural rubber | Weber & Schaer |
| 26.0 | Zonarez B 115 S ® | Poly-pinene resin | Arizona |
| 10.0 | Dertophene T 110 ® | Terpene-phenolic | DRT |
| | | resin | |
| 7.0 | Resin 731 D ® | Rosin | Abieta |
| 7.0 | Nipol 1312 LV ® | Acrylonitrile- | Zeon |
| | | butadiene copolymer | |
| 3.0 | Zinc oxide Weiβsiegel ® | Zinc oxide | Grillo |
| 1.0 | Irganox 1010 ® | Sterically hindered | Ciba-Geigy |
| | | phenol | |

The PSA is prepared and used at a concentration of 20% in petroleum spirit/ethanol (100:5).

Known PSA 3:

(Styrene Block Copolymer-Based Type)

A PSA of the following composition prepared by conventional methods in a compounder is used in solvent-free form:

| Weight | | | |
|---|---|---|---|
| fraction (% | | | |
| by wt.) | Trade name | Chemical basis | Manufacturer/supplier |
| 45.0 | Vector 4113 ® | Styrene-isoprene-styrene block | Exxon Mobil |
| | | copolymer | |
| 45.0 | Escorez 2203 ® | Aromatic-modified | Exxon Mobil |
| | | C-5 hydrocarbon resin | |
| 9.0 | Ondina G41 ® | White oil | Shell Chemicals |
| 1.0 | Irganox 1010 ® | Sterically hindered phenol | Ciba-Geigy |

The following raw materials are used for preparing the ethylene-vinyl acetate copolymer-based PSAs for the more weakly adhering side of adhesive tapes of the invention in the examples. The raw materials stated are all freely available commercially.

| | | Manufacturer/ |
|---|---|---|
| Trade name | Chemical basis | supplier |
| Levapren 450 | Ethylene-vinyl acetate copolymer with | Bayer |
| | 45 weight percent VA fraction | |
| Levapren 600 | Ethylene-vinyl acetate copolymer with | Bayer |
| | 60 weight percent VA fraction | |
| Greenflex | Ethylene-vinyl acetate copolymer with | EniChem |
| ML 60 | 28 weight percent VA fraction | |
| Foral 85 | Adhesive resin (perhydrogenated rosin | Eastman |
| | glyceryl ester) | |
| PolyTHF 2000 | Polytetrahydrofuran, 2000 g/mol | BASF |

The following masses are formulated therefrom:

| Designation of mass | Composition (weight fractions) |
|---|---|
| Mass 1 | Levapren 450 (100) |
| Mass 2 | Levapren 600 + PolyTHF 2000 (90:10) |
| Mass 3 | Greenflex ML 60 + Foral 85 (80:20) |

The coatings with the masses 1 and 2 are effected in the examples on a customary laboratory coating range for continuous coatings having a web width of 50 cm. A comma bar is used as coating assembly. The length of the heating tunnel is about 12 m. The temperature in the heating tunnel is freely choosable between room temperature and 120° C. in each of up to four zones. The adhesive masses are all coated on the backing from a solution in toluene.

A different coating method is adopted with the toluene-insoluble Greenflex ML 60 from mass 3, as described in Examples 7 to 9.

### EXAMPLES 1 TO 3

The PETP backing sheet is first coated conventionally with the known PSAs 1 (Example 1), 2 (Example 2) and 3 (Example 3) and, after the solvent in each case (Examples 1 and 2) has evaporated, the adhesive-coated sheets are rolled up in the heating tunnel and at the same time laminated with standard siliconized release paper. The coatweight is in each case 30 g/m².

The PETP sheet precoated in this way is subsequently coated from the opposite side with the ethylene-vinyl acetate copolymer formulation according to mass 1 by the method described above, in a coatweight of 30 g/m²:

### Characteristic Test Results

more strongly adhering side (known PSAs):

| | |
|---|---|
| bond strength on steel: | >3.0 N/cm |

more weakly adhering side (ethylene-vinyl acetate copolymer PSA):

| | |
|---|---|
| bond strength on steel: | 0.2 N/cm |
| bond strength on the readout side of the CD: | 0.4 N/cm |
| bond strength on the backing side of the CD: | 0.3 N/cm |
| bond strength on paper: | <0.1 N/cm |

long-term bond strength on cylindrical bodies:

| | |
|---|---|
| after 3 months' storage at room temperature: | detachment distance <1 mm |
| after 3 months' storage at +50° C.: | detachment distance <1 mm |
| after 3 months' storage with temperature | detachment distance <1 mm |
| cycling: | |
| residues, deformations, damage: | not visible |
| data readability: | yes |
| adhesion to skin: | no adhesion |

### EXAMPLES 4 TO 6

The BOPP backing sheet is first corona-pretreated on both sides and then coated conventionally with the known PSAs 1 (Example 4), 2 (Example 5) and 3 (Example 6) and, after the solvent in each case (Examples 4 and 5) has evaporated, the adhesive-coated sheets are rolled up in the heating tunnel and at the same time laminated with standard double-sidedly siliconized release paper. The coatweight is in each case 30 g/m².

The BOPP sheet precoated in this way is subsequently coated from the opposite side with the ethylene-vinyl acetate copolymer formulation according to mass 2 by the method described above, in a coatweight of 30 g/m²:

### Characteristic Test Results

more strongly adhering side (known PSAs):

| | |
|---|---|
| bond strength on steel: | >3.0 N/cm |

more weakly adhering side (ethylene-vinyl acetate copolymer PSA):

| | |
|---|---|
| bond strength on steel: | 0.1 N/cm |
| bond strength on the readout side of the CD: | 0.3 N/cm |
| bond strength on the backing side of the CD: | 0.2 N/cm |
| bond strength on paper: | <0.1 N/cm |

long-term bond strength on cylindrical bodies:

| | |
|---|---|
| after 3 months' storage at room temperature: | detachment distance <1 mm |
| after 3 months' storage at +50° C.: | detachment distance <1 mm |
| after 3 months' storage with temperature | detachment distance <1 mm |
| cycling: | |
| residues, deformations, damage: | not visible |
| data readability: | yes |
| adhesion to skin: | no adhesion |

### EXAMPLES 7 TO 9

A laboratory multilayered cast film range is used to coextrude a duplex film consisting of a layer of Elvax 750 in 50 μm thickness together with an ethylene-vinyl acetate copolymer formulation in 25 g/m² according to mass 3 as weakly adhering layer, rolling up at the same time while being laminated with standard double-sidedly siliconized release paper. The extrudate precoated with pressure-sensitive adhesive on one side is then coated from the opposite side with the known more strongly adhering pressure-sensitive adhesives 1 (Example 7), 2 (Example 8) and 3 (Example 9) and, after the respective solvent (Examples 7 and 8) has evaporated in the heating tunnel, is again rolled up on the release paper. The coatweight is in each case 30 g/m², as in the preceding examples.

### Characteristic Test Results

more strongly adhering side (known PSA):

| | |
|---|---|
| bond strength on steel: | >3.0 N/cm |

more weakly adhering side (ethylene-vinyl acetate copolymer PSA):

| | |
|---|---|
| bond strength on steel: | 0.2 N/cm |
| bond strength on the readout side of the CD: | 0.4 N/cm |
| bond strength on the backing side of the CD: | 0.3 N/cm |
| bond strength on paper: | <0.1 N/cm |

long-term bond strength on cylindrical bodies:

| | |
|---|---|
| after 3 months' storage at room temperature: | detachment distance <1 mm |
| after 3 months' storage at +50° C.: | detachment distance <1 mm |
| after 3 months' storage with temperature | detachment distance <1 mm |
| cycling: | |
| residues, deformations, damage: | not visible |
| data readability: | yes |
| adhesion to skin: | no adhesion |

### EXAMPLE 10

A standard, double-sidedly siliconized release paper, is first coated conventionally with the known PSA 1 (Example 1) and, after the solvent has evaporated, the adhesive-coated sheets are rolled up in the heating tunnel. The coatweight is 50 g/m².

The known PSA thus present in coated form is then coated directly first with a polyurethane solution (Desmolac 4125, Bayer) with a coatweight of 1 g/m² and then with an ethylene-vinyl acetate copolymer formulation according to mass 1 by the method described above, in a coatweight of 30 g/m²:

### Characteristic Test Results

more strongly adhering side (known PSA 1):

| | |
|---|---|
| bond strength on steel: | >3.0 N/cm |

more weakly adhering side (ethylene-vinyl acetate copolymer PSA):

| | |
|---|---|
| bond strength on steel: | 0.2 N/cm |
| bond strength on the readout side of the CD: | 0.4 N/cm |
| bond strength on the backing side of the CD: | 0.3 N/cm |
| bond strength on paper: | <0.1 N/cm |

long-term bond strength on cylindrical bodies:

| | |
|---|---|
| after 3 months' storage at room temperature: | detachment distance <1 mm |
| after 3 months' storage at +50° C.: | detachment distance <1 mm |
| after 3 months' storage with temperature | detachment distance <1 mm |
| cycling: | |
| residues, deformations, damage: | not visible |
| data readability: | yes |
| adhesion to skin: | no adhesion |

The examples illustrate that a double-sided adhesive tape according to the present invention wherein one side is embodied with a comparatively strongly adhering known pressure-sensitive adhesive and the other side with a weakly adhering pressure-sensitive adhesive based on ethylene-vinyl acetate copolymers is suitable for fixing flexible data media to surfaces of every-day consumer items or their packaging securely and at the same time ensuring easy, residue- and destruction-free redetachability, the weakly adhering pressure-sensitive adhesive which is exposed on removal of the data medium has no noticeable grab tackiness on human skin.

1. Double-sidedly pressure-sensitive adhesive tape having sides which differ in adhesive strength, comprising at least one adhesive layer, wherein the pressure-sensitive adhesive of the more weakly adhering adhesive layer is based on an ethylene-vinyl acetate copolymer with a vinyl acetate content in the copolymer of from 25 to 92% by weight, the adhesive mass optionally being mixed with additives as selected from the group consisting of tackifying resins, plasticizers, ageing inhibitors and fillers.

2. Double-sidedly pressure-sensitive adhesive tape according to claim 1, wherein the adhesive tape is composed of two adhesive layers of which at least the more weakly adhering side is formed of the EVA-based pressure-sensitive adhesive.

3. Double-sidedly pressure-sensitive adhesive tape according to claim 1, wherein the adhesive tape is composed of a backing layer, which is optionally a laminate of two or more individual layers and on which two adhesive layers are applied in opposition on a backing layer, at least the more weakly adhering side of which is formed of the EVA-based pressure-sensitive adhesive.

4. Double-sidedly pressure-sensitive adhesive tape according to claim 1, wherein the adhesive tape is in the form of punched or cut shapes.

5. Double-sidedly pressure-sensitive adhesive tape according to claim 1, wherein the thickness of the tape is between 20 μm to 300 μm.

6. Double-sidedly pressure-sensitive adhesive tape according to claim 1, wherein the bond strength of the ethylene-vinyl acetate copolymer-based pressure-sensitive adhesive for the more weakly adhering side of the adhesive tape is between 0.01 and 0.4 N/cm, measured on steel, or between 0.1 and 0.8 N/cm, measured on the readout side of the storage medium and/or on the more strongly adhering side adhesive forces on steel, determined at a peel angle of 180° are greater than about 1.0 N/cm.

7. Method for the adhesive bonding and residue-free and damage-free redetachment of flexible storage media to curved, bent, creased, planar or substantially planar surfaces which comprises bonding said storage media to said surfaces with the double-sided pressure-sensitive adhesive tape of claim 1.

8. Method of claim 7, wherein said surfaces are planar or substantially planar surfaces.

9. Method of claim 8, wherein said media is selected from the group consisting of customer cards and credit cards and said planar or substantially planar surfaces are personal letters for sending out the customer cards or credit cards.

10. The Double-sidedly pressure-sensitive adhesive tape of claim 1, wherein said vinyl acetate content is 40 to 70% by weight.

11. The Double-sidedly pressure-sensitive adhesive tape of claim 5, wherein said thickness is 30 μm to 200 μm.

12. The Double-sidedly pressure-sensitive adhesive tape of claim 11, wherein said thickness is 40 μm to 100 μm.

13. The Double-sidedly pressure-sensitive adhesive tape of claim 6, wherein said bond strength of the ethylene-vinyl acetate copolymer-based pressure-sensitive adhesive for the more weakly adhering side of the adhesive tape measured on the readout side of the storage medium is between 0.2 and 0.6 N/cm

14. The double-sidedly pressure-sensitive adhesive tape of claim 6, wherein said bond strength for the more strongly adhering side adhesive forces on steel, determined at a peel angle of 180°, is greater than 2.0 N/cm.

15. The double-sidedly pressure-sensitive adhesive tape of claim 14, wherein said bond strength for the more strongly adhering side adhesive forces on steel, determined at a peel angle of 180°, is greater than 3.0 N/cm.

16. The method of claim 7, wherein said flexible storage media is selected from the group consisting of CDs, CD-ROMs and DVDs.
